(19) United States
(12) Patent Application Publication
(10) Pub. No.: US 2014/0204994 A1
(43) Pub. Date: Jul. 24, 2014

(54) AUXILIARY DATA ENCODING IN VIDEO DATA

(71) Applicant: Silicon Image, Inc., Sunnyvale, CA (US)

(72) Inventor: William Conrad Altmann, San Jose, CA (US)

(73) Assignee: Silicon Image, Inc., Sunnyvale, CA (US)

(21) Appl. No.: 13/787,664

(22) Filed: Mar. 6, 2013

Related U.S. Application Data
(60) Provisional application No. 61/756,412, filed on Jan. 24, 2013.

(51) Int. Cl. H04N 7/26

(52) U.S. Cl. CPC H04N 19/00545
USPC 375/240.01

(57) ABSTRACT

Embodiments of the invention are generally directed to character data encoding in video data. An embodiment of an apparatus includes a port for connection of the apparatus to a second apparatus; and a transmitter for the transmission of video data and auxiliary data to the second apparatus, wherein the apparatus is to encode the auxiliary data into a portion of the video data and to transmit the encoded data to the second apparatus, the auxiliary data being encoded into unused bits of the portion of video data.

### CROSS-REFERENCE TO RELATED APPLICATION

This application claims the benefit of priority from U.S. Provisional Patent Application No. 61/756,412 filed Jan. 24, 2013, which is incorporated herein by reference in its entirety.

### TECHNICAL FIELD

Embodiments of the invention generally relate to the field of data transmission, and, more particularly, to auxiliary data encoding in video data.

### BACKGROUND

For the transmission of signals to a device, such as the transmission of audio-visual data streams, there may be a need to transmit additional auxiliary data, such as closed caption character data. For example, a transmitting system (source) may transmit a video stream to a receiving device (sink) including a display screen, where transmitting device may also be required to provide closed caption information. A conventional system may utilize a standard such as HDMI™ (High Definition Multimedia Interface) or MHL™ (Mobile High-definition Link) for the transmission of the data.

However, digital video links, such as HDMI and MHL, do not provide a synchronous mechanism for sending auxiliary data such as character strings from a source device to a sink. A common use of character strings with video data is in closed captioning. For closed captioning, the caption string needs to be synchronized to the video frames so that each new string is rendered into the final picture only for those frames in which it is pertinent. A caption should not precede nor follow the scene for which the caption applies. Without a synchronous mechanism, there is no assurance that the caption information will be displayed with the appropriate video data.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates transmission of auxiliary data between a source device and a sink device according to an embodiment;

FIG. 2A illustrates pixel data in a first color space to be converted to generate unused bits for auxiliary data encoding according to an embodiment;

FIG. 2B illustrates pixel data in a second color space including unused bits for auxiliary data encoding according to an embodiment;

FIG. 3 illustrates encoding of auxiliary data in video data of a video frame according to an embodiment;

FIG. 4 illustrates encoding of auxiliary data in unused space of pixel data according to an embodiment;

FIG. 5 is a flow chart to illustrate an embodiment of a method for encoding auxiliary data in video data for transmission;

FIG. 6 is a flow chart to illustrate an embodiment of a method for extracting auxiliary data from video data; and

FIG. 7 is an illustration of an apparatus or system for transmitting or receiving auxiliary data encoded in video data.

### SUMMARY

Embodiments of the invention are generally directed to auxiliary data encoding in video data.

In a first aspect of the invention, an embodiment of an apparatus includes a port for connection of the apparatus to a second apparatus; and a transmitter for the transmission of video data and auxiliary data to the second apparatus, wherein the apparatus is to encode the auxiliary data into a portion of the video data and to transmit the encoded data to the second apparatus, the auxiliary data being encoded into unused bits of the portion of video data

In a second aspect of the invention, an embodiment of an apparatus includes a port for connection of the apparatus to a second apparatus; and a receiver for the reception of video data and auxiliary data from the second apparatus. In some embodiments, the apparatus is to identify the auxiliary data encoded in a portion of the video data and to extract the auxiliary data from the portion of the video data, the auxiliary data being encoded into unused bits of the portion of video data.

In a third aspect of the invention, an embodiment of a method includes connecting a first device to a second device for transmission of data including video data from the first device to the second device; determining a capability of the second device for an auxiliary data encoding mode; transmitting a signal from the first device to the second to indicate an intention to change to the auxiliary encoding mode; and inserting auxiliary data into unused space of a portion of the video data.

In a fourth aspect of the invention, an embodiment of a method includes connecting a first device to a second device for reception of data including video data at the first device from the second device; providing a support flag indicating a capability of the first device for an auxiliary data encoding mode; receiving a signal from the second device at the first device to indicate an intention of the second device to change to the auxiliary encoding mode; receiving a portion of video data including encoded auxiliary data, the auxiliary data being stored in bits that are unused for the portion of video data; and extracting the auxiliary data from the portion of the video data.

### DETAILED DESCRIPTION

Embodiments of the invention are generally directed to auxiliary data encoding in video data.

In some embodiments, a method, apparatus, or system provides for auxiliary data encoding in video data, the auxiliary data being encoded in unused space in a portion of the video data. In some embodiments, auxiliary data includes character data, where character data is text data composed of letters, numbers, and other symbols. In some embodiments, data is placed in existing unused space for pixel data. In some embodiments, a portion of video data is converted from an original color space to a color space requiring fewer bits of data to provide additional unused space, the auxiliary data being encoded in the unused space of the portion of video data. In some embodiments, the portion of video data is converted back to the original space for display. In some embodiments, a portion of video data is modified by the reallocation of one or more bits of data used for the encoding of pixel data.

A packet or a control channel may be utilized to send certain auxiliary data such as closed caption data from a source to a sink. However, the packets in HDMI and MHL do not individually have the capacity to carry a complete caption in one packet. For this reason, the source would be required to divide a caption into multiple pieces, and these pieces reassembled at the sink. In addition, using packets for character data adds more packets to the blanking time, increasing the crowding of the available bandwidth, especially in certain video modes.

The control channel offered by HDMI and MHL does not provide a mechanism for auxiliary data such as character strings, and thus, as with packets, a character string would be required to be sent and received in pieces. Further, the control channel in HDMI and MHL is not synchronized to the video frames.

In some embodiments, an apparatus, system, or method includes the transmission of auxiliary data in unused space in video data, where the auxiliary data may include character data. In some embodiments, digital data is transferred across a bus on video links by using binary locations that unused in certain video color spaces. In an example, YC_{b}Cᵣ is a color space where Y=luminance, or intensity; Cb=blue chrominance, the color deviation from gray on a blue-yellow axis; and Cr=red chrominance, the color deviation from gray on a red-cyan axis, where YC_{b}Cᵣ 4:2:2 and YC_{b}Cᵣ 4:4:4 are distinguished by the sampling rate for each component of the pixel data. In an example, when sending YC_{b}Cᵣ 4:4:4 data, there are no unused bits per pixel time. However, when sending YC_{b}Cᵣ 4:2:2 data, there may be 4 or 8 unused bits per pixel time, depending on the color resolution. In some embodiments, the unused binary location in such video color spaces is utilized for encoding of auxiliary data. In some embodiments, video data is converted from a first color space to a second color space to generate unused space for the insertion of auxiliary data.

In some embodiments, one or more bits of pixel data may be replaced with auxiliary data. For example, in an implementation in which there are no unused bits, a certain number of bits, such as one bit per pixel, are reallocated to auxiliary data. In one implementation, a chroma bit (C_{b} or Cᵣ) may be allocated to auxiliary data because this reduction is generally less noticeable to a viewer than a change in luma (Y). In another implementation, a bit of red, green, or blue in an RGB color space may be allocated to auxiliary data.

In some embodiments, the insertion of auxiliary data in video data includes degrading the image quality of a small portion of the overall video image to generate additional unused space for the insertion of the auxiliary data. In some embodiments, auxiliary data is inserted in a line of video data, wherein the line of video data may be a line of video data that provides reduced visual disruption, such as a line at an edge of the video image. In an example, the auxiliary data may be encoded in first line at a top of a video image or a last line at a bottom of a video image.

In some embodiments, the degrading of image quality includes the source device operating to convert video data from a first (original) color space to a second (converted) color space for transmission, where the converted color space requires fewer data bits. Stated in another way, the first color space may be referred to as a higher bit count color space and the second color space may be referred to as a lower bit count color space. In some embodiments, a sink device operates to convert the video data back from the converted color space to the original color space for display. In an example, YC_{b}Cᵣ 4:4:4 may be an original color space. In order to provide additional space for encoding of auxiliary data such as character data, a small portion of the video data is converted to YC_{b}Cᵣ 4:2:2 for transmission, wherein the unused data space in the portion of the video data is used to transmit character data that is related to the video image. In some embodiments, upon receipt of the video data, a sink device extracts the auxiliary data, and converts the data back to YC_{b}Cᵣ 4:4:4, where such conversion will result is some degradation in image quality.

In some embodiments, an apparatus, system or method thus uses the available pixel data bandwidth, and the perceptual limits of the viewer, to reduce the data bandwidth needed for pixel data in one line of each frame and to make that bandwidth available for sending auxiliary data. In some embodiments, video data bandwidth is thus “borrowed” for the purpose of transmitting auxiliary data. In some embodiments, the “borrowed” bandwidth is returned to the video data after the auxiliary data is extracted at the receiving end of the link.

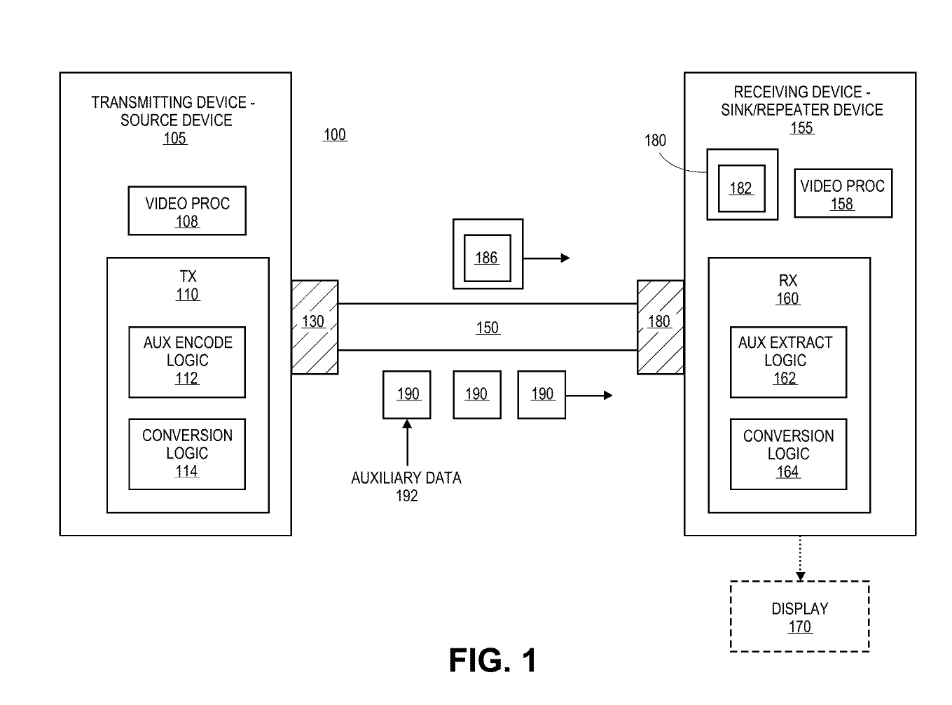

FIG. 1 illustrates transmission of auxiliary data between a source device and a sink device according to an embodiment. In this illustration, in a system 100 a transmitting device 105, which may be referred to as a source device, is coupled to a receiving device 155, which may referred to as a sink device (if the data is consumed by the device) or repeater (if the data is transferred to another device), via a link 150, where the link 150 may include a cable, such as an HDMI or MHL cable. The source device 105 includes a transmitter 110 (or transmitter sub-system) and a connector or other port 130 for a first end of the link 150, and the source device includes a receiver 160 (or receiver sub-system) and a connector or other port 180 for a second end of the link 150. The sink device 155 may further include or be coupled with a display screen 160. In this illustration, the source device 105 further includes a video processor 108 (the upstream video processor) and the sink device 155 includes a video processor 158 (the down stream video processor). In some embodiments, the transmitter further includes an auxiliary data logic 112 for the encoding of auxiliary data into the video data and a conversion logic 114 for converting data from a first form to a second form to generate unused space, such as by converting a portion of video data from a first color space to a second color space or by reallocating one or more bits of the video data to auxiliary data. In some embodiments, the receiver 160 includes an auxiliary data logic 162 for the extraction of auxiliary data from the video data and a conversion logic 164 for converting video data from the second form back into the first form, such as by converting the video data from the second color space to the first color space or by allocating back to video data the one or more bits reallocated for auxiliary data.

The source device 105 is to transmit a data stream to the sink device 155 via the link 150. In some embodiments, the source device is to transmit video data via the link 150. In some embodiments, the source device 105 determines whether the sink device 155 supports an auxiliary data encoding feature, where determining whether the sink device supports the encoded auxiliary data feature includes the source device reading a support flag 182 or other information of the sink, such in configuration data, wherein the support flag may be included in a EDID (Extended Display Identification Data) or capability registers 180 or other similar data of the sink device. In some embodiments, determining whether the sink device supports the auxiliary data encoding feature includes the source device 105 receiving a message from the sink device 155, the sink device transmitting a support flag in the message, the message advertising or otherwise indicating that the sink device 155 supports the encoded auxiliary data feature, where the support flag may be included in a control packet or other data transmitted from the sink device 155 to the source device 105. In some embodiments, the source device 105 transmits an intention flag to the sink device 155 indicating an intention of initiating an auxiliary data encoding mode, where the intention flag may be included in a control packet or other data transmitted from the source device to the sink device. In an example, a flag may be transmitted in an InfoFrame before each frame's data, the flag indicating if the frame has encoded data or not, or a flag may be sent in a separate packet in a data island.

While the description here specifically describes the encoding of a single line of a video frame to include auxiliary data, embodiments are not limited to this particular example. In some embodiments, the auxiliary data is related to the frame of video data, and the encoding synchronizes the auxiliary data with the relevant video data. For example, the auxiliary data may be closed caption data that provides a caption for the video image provided by the video data. In this example, the source device 105 utilizes empty space of the video data to encode the closed caption data. In some embodiments, the source device modifies the original color space coding of the line of the frame of video data to convert the line of data into data using a second, converted color space, wherein the converted color space requires fewer bits of data, or reallocates one or more bits of video data to generate space for the encoding of the closed caption data, where such data will thus be synchronized with the appropriate video data. In some embodiments, the conversion of the video data may occur in the transmitter utilizing the conversion logic 114, while the conversion of the video back to the original form may occur in the receiver utilizing the conversion logic 164.

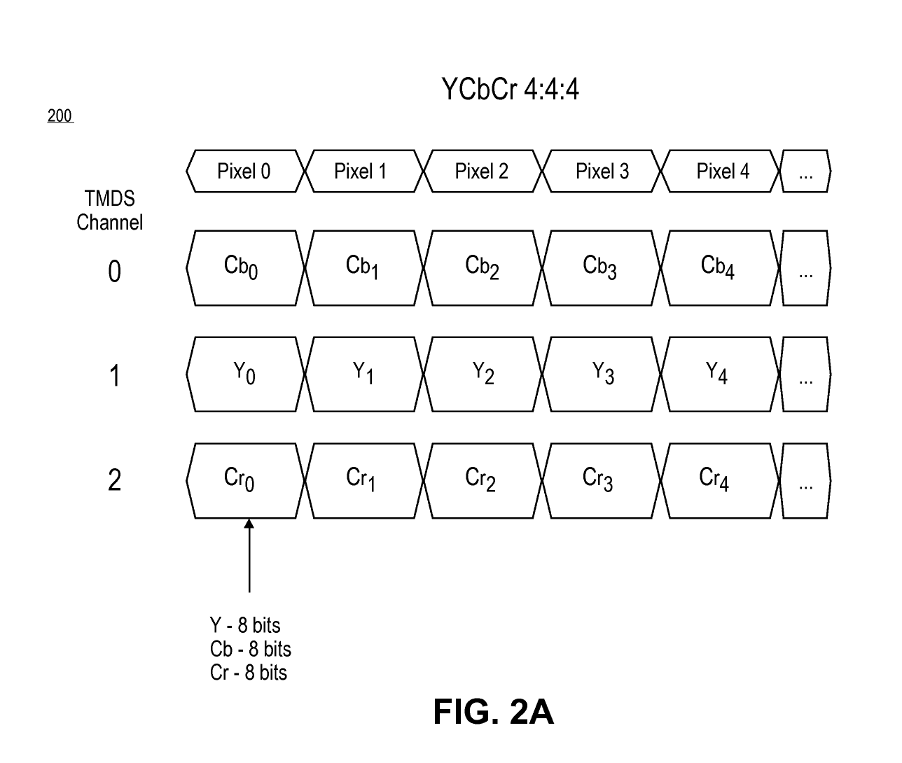

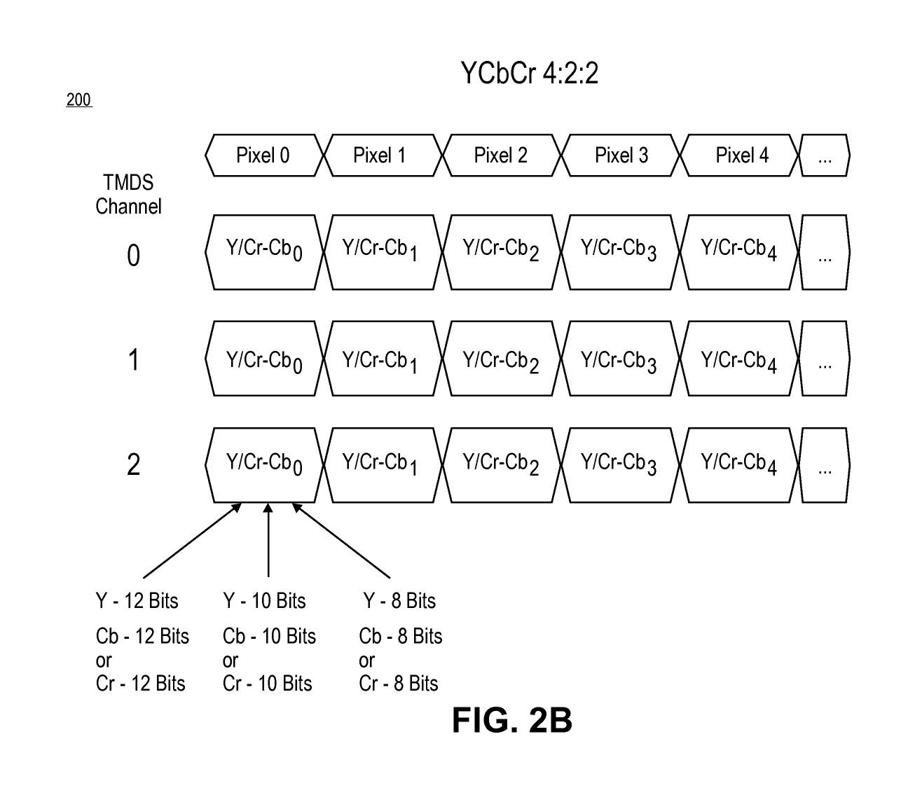

FIG. 2A illustrates pixel data in a first color space to be converted to generate unused bits for auxiliary data encoding according to an embodiment, and FIG. 2B illustrates pixel data in a second color space including unused bits for auxiliary data encoding according to an embodiment. In these illustrations, FIG. 2A provides pixel data in the YC_{b}Cᵣ 4:4:4 color space, and FIG. 2B provides pixel data in the YC_{b}Cᵣ 4:2:2 color space, providing 4 bits of unused space.

As shown in FIG. 2A, pixel data in YC_{b}Cᵣ 4:4:4 will be encoded as 8 bits for each of the Y, C_{b}, and Cᵣ elements. For this reason, each of the illustrated TMDS channels requires 8 bits of data, and then there are no unused bits.

In contrast, pixel data in pixel data in YC_{b}Cᵣ 4:2:2 will may provide unused up to 8 bits of unused space. In such format, the coding will includes the Y component and either the Cb or Cr components. For 12-bit color, this requires 24 bits, and there is no unused space. However, for 10-bit color, there are 4 bits of unused space, and, for 8-bit color, there are 8 bits of unused space.

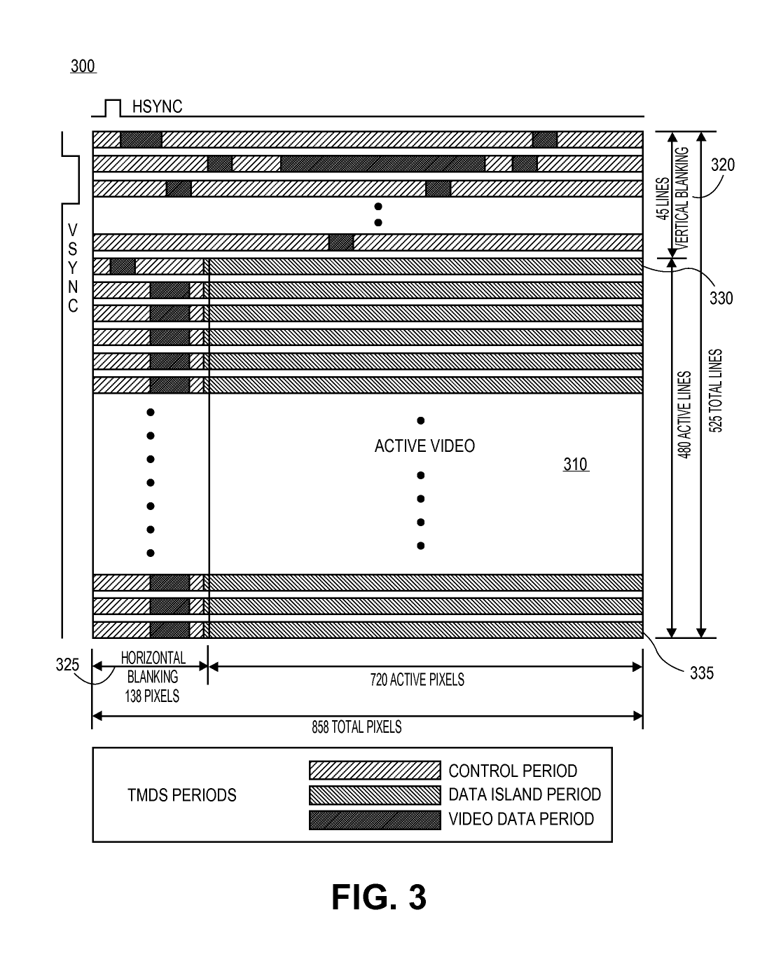

FIG. 3 illustrates encoding of auxiliary data in video data of a video frame according to an embodiment. In some embodiments, an apparatus, system, or method provides for encoded of auxiliary data in data of a video frame, where the auxiliary data is encoded in a manner to reduce visibility to a viewer of displayed data.

In this illustration, a data frame 300 includes active video data 310 (480 lines of active video data in this particular example), as well as a vertical blanking period 320 between periods of active video data and horizontal blanking periods between lines of video data 325 (each line including 720 active pixels). The particular number of lines and pixels is dependent on the type and resolution of a video image. In some embodiments, in order to synchronize auxiliary data, such as character data, to the video data 325, the auxiliary data is encoded within the video data. In some embodiments, the auxiliary data is encoded by modifying the color space of a portion of the video data 310 to generate unused bits for the encoding of the auxiliary data.

In some embodiments, because the modification of the color space of the portion of video data used to encode the auxiliary data results in some degradation of the video data, the portion of video data is chosen to reduce visual impact. In some embodiments, the portion of video data is chosen to be at a beginning or end (or both) of the video data such that the image display is affected only at, for example, the top or bottom (or both) of the image. In this illustration, the portion of video data utilized for encoding of auxiliary data may be a first line or lines 330 of the video data 310 or a last line or lines 335 of the video data such that the portion of the resulting image is affected only at the top, the bottom, or both of the image. In some embodiments, the portion may also be encoded at a right or left edge of the image, with character data being encoded in multiple lines of the video data 310. However, embodiments are limited to a particular portion of the video image.

In some embodiments, a reduction image quality because of the encoding of auxiliary data is transitory because there is a need to convert the color space or reallocate bits only when sending new auxiliary data. With the high bandwidth of the video data, auxiliary data such as closed captions may be sent in a single frame while conventional systems required multiple frames. Thus, in one example, a color space conversion may interrupt only a single frame per second, which is likely an imperceptible change to the viewer.

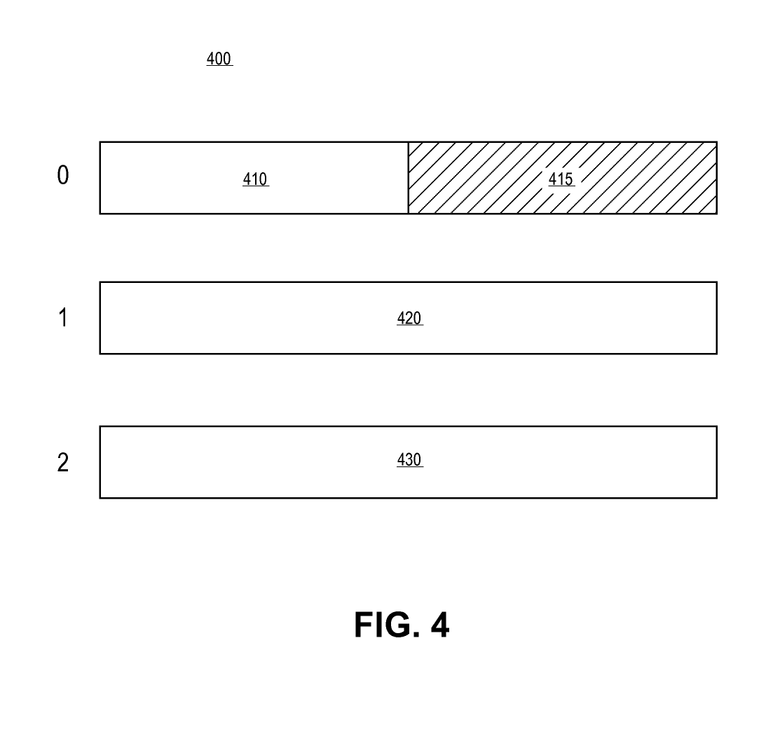

FIG. 4 illustrates encoding of auxiliary data in unused space of pixel data according to an embodiment. In this illustration, data may be encoded in three logical data sub-channels, such as encoding in HDMI or MHL format. For example, pixel data in sub-channels 0, 1, and 2 are 410, 420, and 430. In some embodiments, the encoding of auxiliary data utilizes unused bits in the pixel data. As illustrated, pixel data in a first form, such as, for example, YC_{b}Cᵣ, allows for a certain number of unused bits, which in this illustrated as bits 415. However, there may be no unused bits, or there may be an insufficient number of unused bits. In some embodiments, a transmitter is to convert pixel data from a first form to a second form, such as converting from pixel data in a first color space to pixel data in a second color space, where the second color space allows for additional unused pixels, or such as reallocating one or more bits to auxiliary data. For example, a second color space may be YC_{b}Cᵣ 4:2:2, which allows up to eight unused bits per pixel time, occupying one of the three sub-channels, thereby expanding unused bits 415 in FIG. 4 to encompass the sub-channel 0. In some embodiments, the expanded number of unused bits is utilized for the encoding of auxiliary data. In some embodiments, a receiver is to remove the auxiliary data from the bits 415, and to convert the data back to an original form, thus generating data that is compatible for display with some degradation in quality.

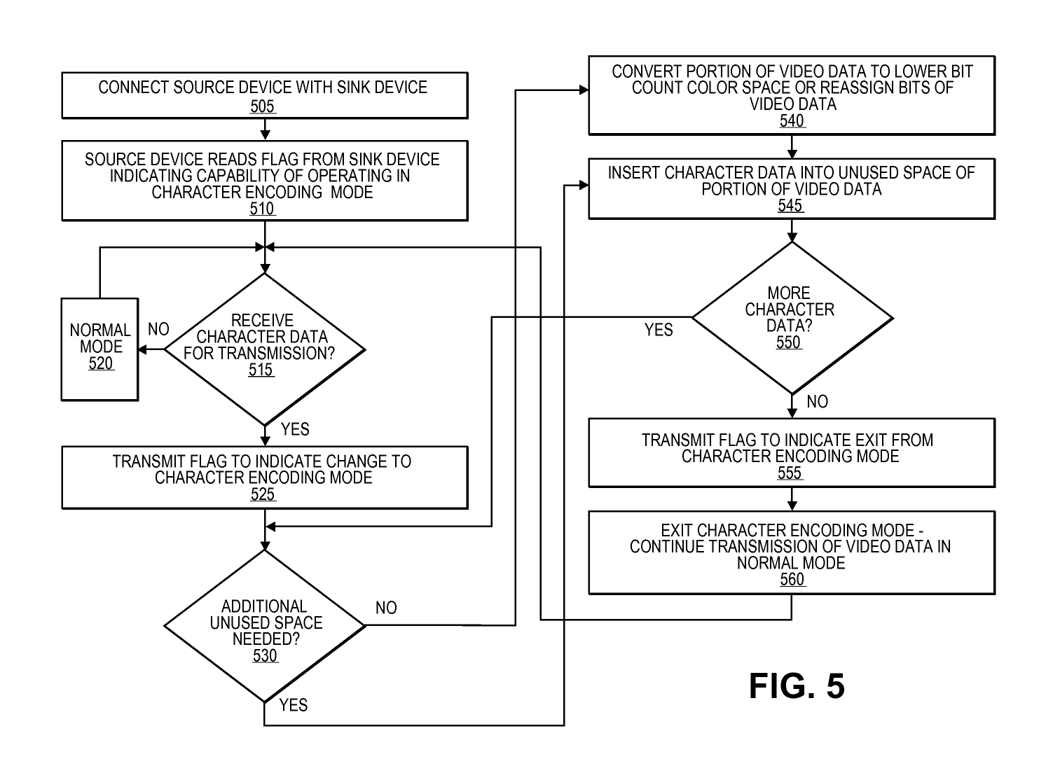

FIG. 5 is a flow chart to illustrate an embodiment of a method for encoding auxiliary data in video data for transmission. In some embodiments, a source device is connected to a sink device 505 for the purpose of delivering video and other data from the source device to the sink device. In some embodiments, the source device reads a flag from the sink device, the flag indicating that the sink can support a mode for transmission of auxiliary data, such as a character encoding mode 510. In some embodiments, a source device may send character data to the transmitter using software or firmware. If the transmitter 515 does not receive character data for transmission 515, the transmitter will operate in a normal mode 520 for the transmission of video and other data to the sink device. If the transmitter does receive character data for transmission 515, the transmitter is to transmit a flag to the sink device to indicate that the source device is initiating the character encoding mode 525.

In some embodiments, the transmitting subsystem encodes the character data into an active video frame, wherein the encoding uses a portion of the video data, such as one line of the active video frame. In some embodiments, if additional unused space is needed to encode character data 530, then the portion of video data is converted to a lower bit count color space, or a certain number of bits video data are reassigned to auxiliary data. For example, each pixel in the video line is input to the transmitter subsystem may be in a higher bit count color space (for example, YC_{b}Cᵣ 4:4:4 mode) or in a lower bit count color space (YC_{b}Cᵣ 4:2:2 mode). If the video data is in the high bit count color space, thus the incoming pixel being in YC_{b}Cᵣ 4:4:4 mode in this example, the transmitter subsystem uses logic circuits to convert the portion of video data to the lower bit count mode 540, such as converting the pixel's color data into YC_{b}Cᵣ 4:2:2. For example, the pixel's video data in YC_{b}Cᵣ 4:2:2 mode providing 8-bit color may occupy only two of the three logical sub-channels in the HDMI or MHL encoding stream, using only sixteen of the available twenty-four data bits per pixel. In some embodiments, the transmitter subsystem is to insert the character data into the unused space of the portion of video data, such as, using the remaining eight unused data bits of the logical sub-channels, one byte of the character data is written into the third logical sub-channel. In some embodiments, the three logical sub-channels, holding one pixel's data and one byte of the character data, are encoded into TMDS characters according to the normal HDMI or MHL protocol.

In some embodiments, if there is more character data to be transmitted 550, the encoding of character data may continue. If not, in some embodiments the transmitter transmits a flag to indicate an exit from the character encoding mode 555. In other embodiments, a flag to indicate an exit from the character encoding mode is not required, such as when the source device and sink device will automatically exit the character encoding mode after the encoding of character data in a video frame. In some embodiments, the transmitter exits the character encoding mode, and continues with transmission of video data in the normal mode 560.

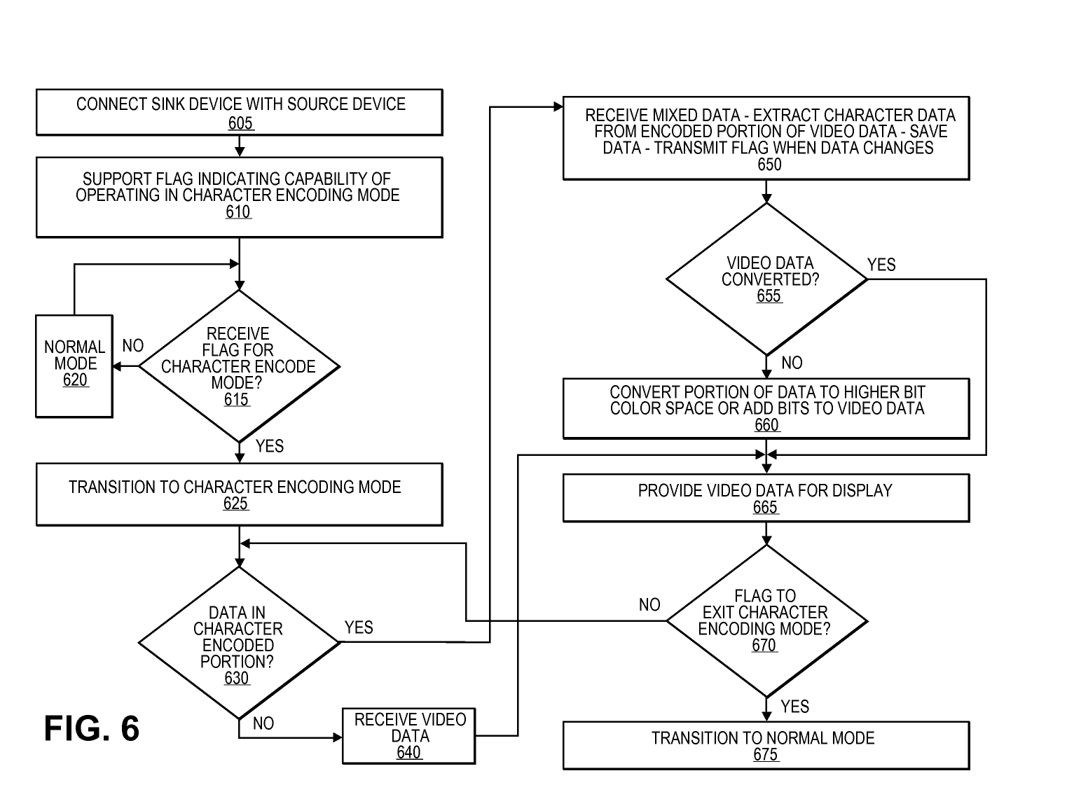

FIG. 6 is a flow chart to illustrate an embodiment of a method for extracting auxiliary data from video data. In some embodiments, a sink device is connected to a source device 605, such as connecting the devices via a cable. In some embodiments, the sink device may include a support flag indicating a capability of operating in a character encoding mode 610. In some embodiments, if the sink has not received a flag from the source device indicating an intention of operating in a character encoding mode 615, the sink device operates in a normal mode for receipt of video data 620. Upon receiving a flag indicating the character encoding mode 615, the sink device transitions to the character encoding mode 625.

In some embodiments, the character encoding mode indicates that character data is located in certain portion of the video data, such as the first line or last line of the video frame. The sink device receives the video stream, including the character data in a portion of a video frame. The receiver subsystem recognizes the modified data in, for example, one line of the video frame, according to the mode flag. If the received data is not in the character encoded portion (data in other lines of the video frame) 660, then the video data is received 640 and is provided for display 665. If the received data is in the character encoded portion 630, then mixed data is received, and the sink's receiver subsystem extracts the character data from the line in each frame, and saves the character data utilizing logic 650. For example, the receiver subsystem decodes the TMDS character at each pixel time in the active line into one 24-bit value. Sixteen bits of the 24-bit value are interpreted as a YC_{b}Cᵣ 4:2:2 pixel data value, and eight bits of the 24-bit value are interpreted as one byte of character data.

If the video data has been converted from a first form to second form for the encoding of the auxiliary data into the video data 655, the video data is converted back to the first form, such as by converting the video from a lower bit count color space into a higher bit count color space, or by allocating one or more bits back to the video data. For example, if the video stream is being sent in YC_{b}Cᵣ 4:2:2 mode (as indicated in the AVI InfoFrame) and a third sub-channel contained auxiliary data, then the third sub-channel is blanked to a zero value, and the 24-bit value is sent onward to the sink's video processor as normal YC_{b}Cᵣ 4:2:2 data. However, if the video stream is being sent in YC_{b}Cᵣ 4:4:4 mode (as in the AVI InfoFrame), then the receiver subsystem's logic processes the 16-bit YC_{b}Cᵣ 4:2:2 value through a color space converter back into a 24-bit YC_{b}Cᵣ 4:4:4 value. This value is sent onward as part of the normal YC_{b}Cᵣ 4:4:4 stream for video display 665.

In some embodiments, if an additional flag is received indicating an exit from the character encoding mode 670, the sink device may return to the normal mode 675. However, the additional flag is not required in all embodiments, and the sink device may automatically return to the normal mode.

In some embodiments, the sink device sends a flag to the sink's main video system each time the extracted character data changes. The 8-bit character data is joined with the character data from preceding and succeeding pixel times in the same video frame to create a complete character string. If this string has a value different from the value of the character string in the preceding video frame, then a signal is sent to the sink's processor (such as an interrupt). The sink's main video system reads the character data from the receiver's logic each time the data changes, and incorporates that data into the rendered picture, or otherwise processes the character data.

It is noted that an encoded character string or other auxiliary data may be supplemented by other data, such as header bits, character space flags (such as to distinguish 7-bit ASCII from larger Unicode encoding), error detection and error correction bits (to guard against single- or multi-bit errors in the encoded string data), stream index values (to allow for multiple types of strings in one video stream), and other such data.

Further, the data carried in the line of video in the unused space may be formatted in any of a variety of ways. With, for example, a suitable header on the line of data, the format of the subsequent bytes will be understood by the receiver. Further, with data error detection and correction mechanisms, the integrity of the data may be assured.

In some embodiments, extra data does not need to be transmitted on every frame of video. After sending the data in one frame, if the data on the transmitter does not change, then the normal video pixel data can resume in the next frames. The receiver may be keyed to this if the data is pipelined in the transmitter by one frame time so that a flag can be added at the end of one frame to indicate if the next frame has encoded data instead of pixel data.

In an alternative embodiment, a flag in an InfoFrame before each frame's data may indicate if the frame has encoded data or not; or a flag may be in a separate packet in a data island. In some embodiments, intermittent transfer of a flag to indicate character data encoding may be utilized to facilitate encoding data across a link in parallel with YC_{b}Cᵣ 4:2:2 pixel data, even though the main stream of video data is 24-bits per pixel, in either RGB or YC_{b}Cᵣ. When there is data to be sent across, the video line's pixel data may be converted with a color space converter into YC_{b}Cᵣ 4:2:2 8-bit (or 10-bit). Then, when the data transmit is complete, the color space can revert back.

In some embodiments, a downstream video processor in the sink is not aware of the conversion process in an implementation in which the handling of the auxiliary data and data conversion is separate from the video processor, such as, for example, a sink device in which the handling is done in the port processor. Similarly, in some embodiments, an upstream video processor in the source is not be aware of the conversion process in an implementation in which the handling of the auxiliary data and data conversion is separate from the video processor, such as, for example, in a source in which the transmitter handles the conversion process, and accepts the data bytes as input separate from the video and audio streams.

In an implementation of an apparatus or system, modification of pixel data in one line of a frame (such as the first line or last line) will not affect the overall CEA-861-compliant timings, and thus there is no effect on overall HDMI compliance, and no effect on HDMI Repeaters that can pass this data through unchanged. There are no additional packets required, other than a mechanism for the source to inform the sink that this mechanism is being used.

In some embodiments, a source may insert the auxiliary data into the video stream without informing the sink. If the sink is capable of recognizing character data in the video line (as indicated in a support flag in its EDID or Capability Registers), then the sink may be operable to be prepared to recognize data there by a signature in the character line or other related means. In such an embodiment, the source may begin sending character data immediately upon seeing a support flag in the sink's configuration. In some embodiments, a port processor, or other receiver subsystem, may detect the incoming auxiliary data (such as in YC_{b}Cᵣ 4:2:2 data), and convert the video data by substituting an approximation of the original (such as in YC_{b}Cᵣ 4:4:4 mode) pixel data, which may result in some degradation in the video data. In some embodiments, the receiver subsystem then sends the pixel stream to the downstream video processor, which is not aware that there had been auxiliary data in the stream between source and sink.

In an alternative embodiment, rather than converting data between color spaces or reallocating bits, through the use of a single line buffer, a receiver subsystem can store the pixel data from a second-to-last line in the frame, and repeat that pixel data in the last line of the frame when it extracts the character string. This repeated-line approach may be perceived differently by the viewer than converting YC_{b}Cᵣ 4:4:4 to YC_{b}Cᵣ 4:2:2 and then back to YC_{b}Cᵣ 4:4:4, or by reallocating bits back to video data.

In an implementation of a transmitter, by inserting one byte of data as character data into each pixel time on the link, the bandwidth achieved may far exceed the bandwidth that is available on the control bus. Further, in such operation there is no need to arbitrate use of a control bus because there is no interference between the encoded data and the normal YC_{b}Cᵣ 4:2:2 video data.

Further, in operation latency is minimized as the encoded data is synchronized with the video data frames. There may be a latency caused by the micro-controller putting the data into the transmitter's queue, and pulling it from the receiver's queue, but the link itself guarantees low latency.

Table 1 and Table 2 show the bandwidth available in certain examples of video modes.

TABLE 1
Bandwidth per Video Mode with 8-bit YC_{b}Cᵣ Video

| Mode | V Rate | Bytes/Frame | Bytes/Second |
|---|---|---|---|
| 480p | 60 | 640 | 38400 |
| 720p | 60 | 1080 | 64800 |
| 1080i | 60 | 1920 | 115200 |
| 1080p | 24 | 1920 | 46080 |
| 1080p | 60 | 1920 | 115200 |

TABLE 2
Bandwidth per Video Mode with 10-bit YC_{b}Cᵣ Video

| Mode | V Rate | Bytes/Frame | Bytes/Second |
|---|---|---|---|
| 480p | 60 | 320 | 19200 |
| 720p | 60 | 540 | 32400 |
| 1080i | 60 | 960 | 57600 |
| 1080p | 24 | 960 | 23040 |
| 1080p | 60 | 960 | 57600 |

For comparison, EIA-608 defines a character space that can send two characters in two bytes, but only provides 960 bits per second. This translates to 120 bytes per second. An embodiment utilizing a YC_{b}Cᵣ carrier is capable of handling data at 100 times this load.

Character data may be encoded as 7-bit ASCII, 8-bit ASCII (part of the Unicode space), or single- to multi-byte Unicode characters. This allows support of worldwide languages, and may be selected by the user on the source device, or read back from the sink device's preselected menu language.

Auxiliary data may include character coding that is utilized for text that is superimposed or otherwise presented on a video image. Uses may include presentation of a text message on a screen. For example, user text strings can be sent from source to sink as follows:

(1) A phone is connected to a television at a first input port, while the user is viewing content on a second input port of the television.

(2) The phone receives a text message (or a phone call), and transmits text message (or caller ID information) to the television, where the data is transferred in a YC_{b}Cᵣ 4:2:2 mode link, the link being maintained in a connected state to sustain HDCP and to minimize port switching times.

(3) The television recognizes the character data and (if configured for this purpose at the television end and the phone end by the user) the television displays the message on screen with the on-screen display generator. In some embodiments, the OSD function is performed in the port-processor, without affecting the downstream application processor at all.

In some embodiments, auxiliary data encoding includes closed captioning for video. Text characters for closed captioning are sent in the video data stream, synchronized with the video frames, and not affecting the control bus. In some embodiments, the port processor interprets the incoming text and formats it into an OSD message, or passes it on to the downstream application processor.

A smart dongle or smart port processor can have embedded firmware. An update can be sent to this firmware across the link from the Source, using the data in the YC_{b}Cᵣ space.

In some embodiments, color translation tables in a dongle or port processor may be updated with new multiplier codes or lookup tables, to support new color spaces, with data sent across the link. In some embodiments, such data re-configures a color space converter every time the specific Source is connected, or every time the specific application is used which wants to send out video in a particular format.

In some embodiments, low rate audio may be encoded in video data for transmission using the YC_{b}Cᵣ data space. In some embodiments, the audio data runs in parallel with the audio accompanying the video stream (for example, the sound track to a movie), but without depending on the audio sample rate or format of that ‘primary link. An example of this usage is phone call audio—even a ring tone—sent across the link while normal audio is running. This ring tone could be sounded while the normal audio is automatically muted by the sink. (Note: A sink could mute audio from a different source device when it recognizes audio from the source sending across YC_{b}Cᵣ.)

In some embodiments, a sink device could indicate to the user that audio is arriving by lighting an LED or lamp, instead of outputting the audio itself.

In some embodiments, a source may send a specific data string periodically as auxiliary data in order to check the signal integrity of the link. The data values may be selected to create optimally measured performance, such as encoded values that are most error-prone. In some embodiments, the link integrity data may not need to occupy an entire line or every line per second of video. Other user data can be carried along with the link integrity data.

In some embodiments, a source may signal to the sink specifics about the source's capabilities, using the data in the YC_{b}Cᵣ pixel values. An example is a “smart cable”, which substitutes the configuration data for the originating YC_{b}Cᵣ zeroes, and communicates to the sink device parameters such as cable length, cable maximum bandwidth, etc.

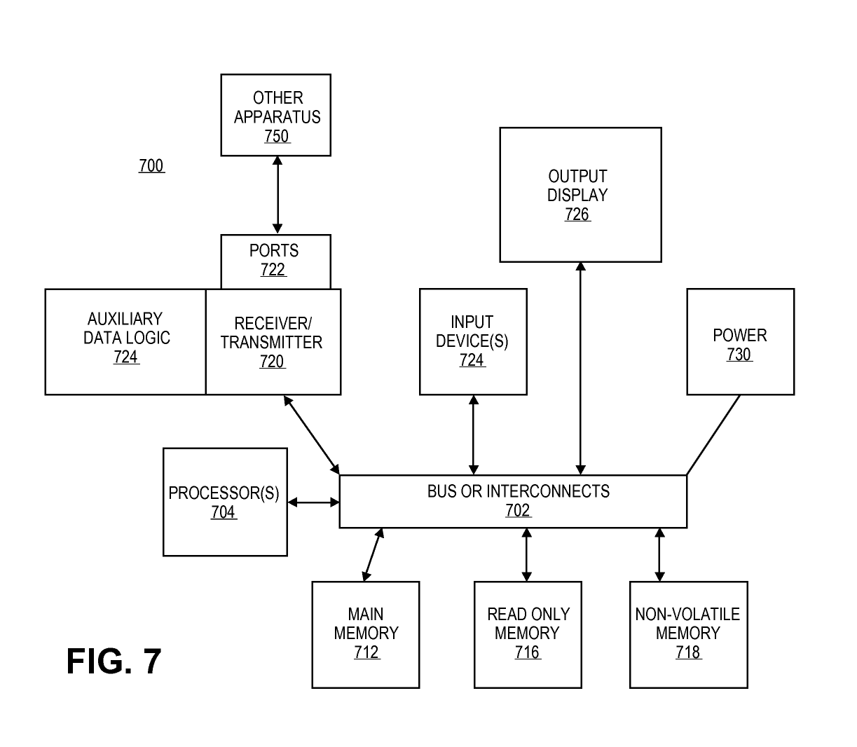

FIG. 7 is an illustration of an apparatus or system for transmitting or receiving auxiliary data encoded in video data. In some embodiments, the apparatus or system provides for the encoding of auxiliary data in unused space of video data and the transmission of the encoded data, or the apparatus or system provides for the reception and extraction of the video data from the video data.

In some embodiments, an apparatus or system 700 (referred to here generally as an apparatus) comprises an interconnect or crossbar 702 or other communication means for transmission of data. The apparatus 700 may include a processing means such as one or more processors 704 coupled with the interconnect 702 for processing information. The processors 704 may comprise one or more physical processors and one or more logical processors. The interconnect 702 is illustrated as a single interconnect for simplicity, but may represent multiple different interconnects or buses and the component connections to such interconnects may vary. The interconnect 702 shown in FIG. 7 is an abstraction that represents any one or more separate physical buses, point-to-point connections, or both connected by appropriate bridges, adapters, or controllers.

In some embodiments, the apparatus 700 further comprises a random access memory (RAM) or other dynamic storage device or element as a main memory 712 for storing information and instructions to be executed by the processors 704. In some embodiments, main memory may include active storage of applications including a browser application for using in network browsing activities by a user of the apparatus 700. In some embodiments, memory of the apparatus may include certain registers or other special purpose memory.

The apparatus 700 also may comprise a read only memory (ROM) 716 or other static storage device for storing static information and instructions for the processors 704. The apparatus 700 may include one or more non-volatile memory elements 718 for the storage of certain elements, including, for example, flash memory and a hard disk or solid-state drive.

One or more transmitters or receivers 720 may also be coupled to the interconnect 702. In some embodiments, the receivers or transmitters 720 may include one or more ports 722 for the connection of other apparatuses, such as the illustrated 750.

The apparatus 700 may also be coupled via the interconnect 702 to an output display 726. In some embodiments, the display 726 may include a liquid crystal display (LCD) or any other display technology, for displaying information or content to a user, including three-dimensional (3D) displays. In some environments, the display 726 may include a touch-screen that is also utilized as at least a part of an input device. In some environments, the display 726 may be or may include an audio device, such as a speaker for providing audio information. In some embodiments, the apparatus 700 includes auxiliary data logic 724, where the auxiliary data logic provides for handling of the transmission or reception of auxiliary data, where the handling of such data includes encoding the auxiliary data into video data for transmission or extracting the auxiliary data from received data.

The apparatus 700 may also comprise a power device or apparatus 730, which may comprise a power supply, a battery, a solar cell, a fuel cell, or other system or device for providing or generating power. The power provided by the power device or system 730 may be distributed as required to elements of the apparatus 700.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

The present invention may include various processes. The processes of the present invention may be performed by hardware components or may be embodied in computer-readable instructions, which may be used to cause a general purpose or special purpose processor or logic circuits programmed with the instructions to perform the processes. Alternatively, the processes may be performed by a combination of hardware and software.

Portions of the present invention may be provided as a computer program product, which may include a computer-readable non-transitory storage medium having stored thereon computer program instructions, which may be used to program a computer (or other electronic devices) to perform a process according to the present invention. The computer-readable storage medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

In some embodiments, an apparatus includes a port for connection of the apparatus to a second apparatus; and a transmitter for the transmission of video data and auxiliary data to the second apparatus. The wherein the apparatus is to encode the auxiliary data into a portion of the video data and to transmit the encoded data to the second apparatus, the auxiliary data being encoded into unused bits of the portion of video data.

In some embodiments, the auxiliary data is character data. In some embodiments, the portion of the video data is one or more lines of a video frame. In some embodiments, the portion of the video data is a first line or a last line of the video frame.

In some embodiments, the transmitter includes a logic to encode the auxiliary data into the portion of the video.

In some embodiments, the transmitter includes a conversion logic to convert the portion of the video data from a first form to a second form.

In some embodiments, the conversion logic is to convert the portion of video data from a first color space to a second color space prior to encoding of the auxiliary data into the portion of the video data, the second color space requiring fewer bits than the first color space. In some embodiments, the first color space is YCbCr 4:4:4 and the second color space is YCbCr 4:2:2.

In some embodiments, the conversion logic is to reduce a number of bits used to encode the portion of the video data by one or more bits to generate one or more bits for the encoding of the auxiliary data. In some embodiments, a color space of the portion of video data includes a luminance portion and a chrominance portion, and wherein the one or more bits are contained in the chrominance portion.

In some embodiments, an apparatus includes a port for connection of the apparatus to a second apparatus; and a receiver for the reception of video data and auxiliary data from the second apparatus. In some embodiments, the apparatus is to identify the auxiliary data encoded in a portion of the video data and to extract the auxiliary data from the portion of the video data, the auxiliary data being encoded into unused bits of the portion of video data.

In some embodiments, the auxiliary data is character data. In some embodiments, the portion of the video data is one or more lines of a video frame.

In some embodiments, the receiver includes a logic to extract the auxiliary data from the portion of the video.

In some embodiments, the receiver includes a conversion logic to convert the portion of the video data from a first form to a second form, the second form being a form of the video data prior to encoding of the auxiliary data.

In some embodiments, the conversion logic is to convert the portion of video data from a first color space to a second color space after the extraction of the auxiliary data from the portion of the video data, the second color space requiring one or more bits than the first color space, the auxiliary data being encoded in the one or more bits before extraction.

In some embodiments, the conversion logic is to increase a number of bits used to encode the portion of the video data by one or more bits after the extraction of the auxiliary data from the portion of the video data, the auxiliary data being encoded in the one or more bits before extraction.

In some embodiments, a method includes connecting a first device to a second device for transmission of data including video data from the first device to the second device; determining a capability of the second device for an auxiliary data encoding mode; transmitting a signal from the first device to the second to indicate an intention to change to the auxiliary encoding mode; and inserting auxiliary data into unused space of a portion of the video data.

In some embodiments of the method, the auxiliary data is character data. In some embodiments of the method, the portion of the video data is one or more lines of a video frame to be transmitted from the first device to the second device. In some embodiments, the portion of the video data is a first line or a last line of the video frame.

In some embodiments, determining the capability of the second device for the auxiliary data encoding mode includes reading a support flag of the second device. the support flag is provided in one or more of a configuration to be accessed by the first device or a signal sent from the second device to the first device.

In some embodiments, the method further includes determining if additional unused spaced is needed to encode the auxiliary data, and, upon determining that additional unused spaced is needed, converting the portion of the video data from a first form to a second form, the second form providing more unused space than the first form. In some embodiments, the method further includes converting the portion of video data from a first color space to a second color space prior to encoding of the auxiliary data into the portion of the video data, the second color space requiring fewer bits than the first color space. In some embodiments, the method further includes reducing a number of bits used to encode the portion of the video data by one or more bits to generate one or more unused bits for the encoding of the auxiliary data.

In some embodiments, a method includes connecting a first device to a second device for reception of data including video data at the first device from the second device; providing a support flag indicating a capability of the first device for an auxiliary data encoding mode; receiving a signal from the second device at the first device to indicate an intention of the second device to change to the auxiliary encoding mode; receiving a portion of video data including encoded auxiliary data, the auxiliary data being stored in bits that are unused for the portion of video data; and extracting the auxiliary data from the portion of the video data.

In some embodiments, the auxiliary data is character data. In some embodiments, the portion of the video data is one or more lines of a received video frame. In some embodiments, the portion of the video data is a first line or a last line of the video frame.

In some embodiments, providing a support flag indicating a capability of the first device for an auxiliary data encoding mode includes storing the flag in a configuration of the first device. In some embodiments, providing a support flag indicating a capability of the first device for an auxiliary data encoding mode includes transmitting the flag in a message to the first device.

In some embodiments, the method further includes converting the portion of video data from a first form to a second form after extraction of the auxiliary data if the portion of video data was converted from the second form to the first form to provide unused space for the auxiliary data. In some embodiments, the method further includes converting the portion of video data from a first color space to a second color space after the extraction of the auxiliary data from the portion of the video data, the second color space requiring one or more additional bits than the first color space, the auxiliary data being encoded in the one or more bits before extraction. In some embodiments, the method further includes increasing a number of bits used to encode the portion of the video data by one or more bits after the extraction of the auxiliary data from the portion of the video data, the auxiliary data being encoded in the one or more bits before extraction.

What is claimed is:

1. An apparatus comprising:
a port for connection of the apparatus to a second apparatus; and
a transmitter for the transmission of video data and auxiliary data to the second apparatus;
wherein the apparatus is to encode the auxiliary data into a portion of the video data and to transmit the encoded data to the second apparatus, the auxiliary data being encoded into unused bits of the portion of video data.

2. The apparatus of claim 1, wherein the auxiliary data is character data.

3. The apparatus of claim 1, wherein the portion of the video data is one or more lines of a video frame.

4. The apparatus of claim 3, wherein the portion of the video data is a first line or a last line of the video frame.

5. The apparatus of claim 1, wherein the transmitter includes a logic to encode the auxiliary data into the portion of the video.

6. The apparatus of claim 1, wherein the transmitter includes a conversion logic to convert the portion of the video data from a first form to a second form.

7. The apparatus of claim 6, wherein the conversion logic is to convert the portion of video data from a first color space to a second color space prior to encoding of the auxiliary data into the portion of the video data, the second color space requiring fewer bits than the first color space.

8. The apparatus of claim 7, wherein the first color space is YC_{b}Cᵣ 4:4:4 and the second color space is YC_{b}Cᵣ 4:2:2.

9. The apparatus of claim 6, wherein the conversion logic is to reduce a number of bits used to encode the portion of the video data by one or more bits to generate one or more bits for the encoding of the auxiliary data.

10. The apparatus of claim 9, wherein a color space of the portion of video data includes a luminance portion and a chrominance portion, and wherein the one or more bits are contained in the chrominance portion.

11. An apparatus comprising:
a port for connection of the apparatus to a second apparatus; and
a receiver for the reception of video data and auxiliary data from the second apparatus;
wherein the apparatus is to identify the auxiliary data encoded in a portion of the video data and to extract the auxiliary data from the portion of the video data, the auxiliary data being encoded into unused bits of the portion of video data.

12. The apparatus of claim 11, wherein the auxiliary data is character data.

13. The apparatus of claim 11, wherein the portion of the video data is one or more lines of a video frame.

14. The apparatus of claim 13, wherein the portion of the video data is a first line or a last line of the video frame.

15. The apparatus of claim 11, wherein the receiver includes a logic to extract the auxiliary data from the portion of the video.

16. The apparatus of claim 11, wherein the receiver includes a conversion logic to convert the portion of the video data from a first form to a second form, the second form being a form of the video data prior to encoding of the auxiliary data.

17. The apparatus of claim 16, wherein the conversion logic is to convert the portion of video data from a first color space to a second color space after the extraction of the auxiliary data from the portion of the video data, the second color space requiring one or more bits than the first color space, the auxiliary data being encoded in the one or more bits before extraction.

18. The apparatus of claim 16, wherein the conversion logic is to increase a number of bits used to encode the portion of the video data by one or more bits after the extraction of the auxiliary data from the portion of the video data, the auxiliary data being encoded in the one or more bits before extraction.

19. A method comprising:
connecting a first device to a second device for transmission of data including video data from the first device to the second device;
determining a capability of the second device for an auxiliary data encoding mode;
transmitting a signal from the first device to the second to indicate an intention to change to the auxiliary encoding mode; and
inserting auxiliary data into unused space of a portion of the video data.

20. The method of claim 19, wherein the auxiliary data is character data.

21. The method of claim 20, wherein the portion of the video data is one or more lines of a video frame to be transmitted from the first device to the second device.

22. The method of claim 20, wherein the portion of the video data is a first line or a last line of the video frame.

23. The method of claim 19, wherein determining the capability of the second device for the auxiliary data encoding mode includes reading a support flag of the second device.

24. The method of claim 23, wherein the support flag is provided in one or more of a configuration to be accessed by the first device or a signal sent from the second device to the first device.

25. The method of claim 19, further comprising determining if additional unused spaced is needed to encode the auxiliary data, and, upon determining that additional unused spaced is needed, converting the portion of the video data from a first form to a second form, the second form providing more unused space than the first form.

26. The method of claim 25, further comprising converting the portion of video data from a first color space to a second color space prior to encoding of the auxiliary data into the portion of the video data, the second color space requiring fewer bits than the first color space.

27. The method of claim 25, further comprising reducing a number of bits used to encode the portion of the video data by one or more bits to generate one or more unused bits for the encoding of the auxiliary data.

28. A method comprising:
connecting a first device to a second device for reception of data including video data at the first device from the second device;
providing a support flag indicating a capability of the first device for an auxiliary data encoding mode;
receiving a signal from the second device at the first device to indicate an intention of the second device to change to the auxiliary encoding mode;
receiving a portion of video data including encoded auxiliary data, the auxiliary data being stored in bits that are unused for the portion of video data; and
extracting the auxiliary data from the portion of the video data.

29. The method of claim 28, wherein the auxiliary data is character data.

30. The method of claim 28, wherein the portion of the video data is one or more lines of a received video frame.

31. The method of claim 30, wherein the portion of the video data is a first line or a last line of the video frame.

32. The method of claim 28, wherein providing a support flag indicating a capability of the first device for an auxiliary data encoding mode includes storing the flag in a configuration of the first device.

33. The method of claim 28, wherein providing a support flag indicating a capability of the first device for an auxiliary data encoding mode includes transmitting the flag in a message to the first device.

34. The method of claim 28, further comprising converting the portion of video data from a first form to a second form after extraction of the auxiliary data if the portion of video data was converted from the second form to the first form to provide unused space for the auxiliary data.

35. The method of claim 34, further comprising converting the portion of video data from a first color space to a second color space after the extraction of the auxiliary data from the portion of the video data, the second color space requiring one or more additional bits than the first color space, the auxiliary data being encoded in the one or more bits before extraction.

36. The method of claim 34, further comprising increasing a number of bits used to encode the portion of the video data by one or more bits after the extraction of the auxiliary data from the portion of the video data, the auxiliary data being encoded in the one or more bits before extraction.
